(19) United States
(12) Patent Application Publication
(10) Pub. No.: US 2015/0367495 A1
(43) Pub. Date: Dec. 24, 2015

(54) POWER TOOL

(71) Applicant: HITACHI KOKI CO., LTD., Minato-ku, Tokyo (JP)

(72) Inventor: Yuuki TAKEDA, Ibaraki (JP)

(21) Appl. No.: 14/767,583

(22) PCT Filed: Jan. 31, 2014
(86) PCT No.: PCT/JP2014/052277

§ 371 Date: Aug. 12, 2015

(30) Foreign Application Priority Data
Feb. 28, 2013 (JP) 2013-038245

(51) Int. Cl. B25F 5/00; B24B 23/02; B25F 5/02

(52) U.S. Cl. CPC B25F 5/006; B25F 5/02; B24B 23/028

(57) ABSTRACT

For providing a power tool capable of significantly reducing the transmission of vibrations to the housing 40 held by a user, the inner cover 30 for covering an opening at a front end of the housing 40 is attached at the front end of the housing 40 of the grinder 10 and the gear cover 20 is attached with screws 36 on a front side of the inner cover 30. When the gear cover 20 is attached to the inner cover 30, the elastic member 70 is disposed in the recess shape 60 formed at the fixing part between the inner cover 30 and the gear cover 20 and the locking part of the housing 40 is fitted so as to be locked to the elastic member 70.

### TECHNICAL FIELD

The present invention relates to a power tool, and in particular, relates to a power tool used for grinding, polishing, and other tasks by rotating a tip tool such as a disc-shaped grindstone.

### BACKGROUND ART

For the surface grinding work to evenly grind a surface of a workpiece material such as concrete, a portable power tool referred to as a grinder equipped with a disc-shaped (wheel-shaped) tip tool is often used.

In such a surface grinding work using a grinder, an entire surface of a tip tool is pressed evenly to a surface of a workpiece material, and the tip tool is moved in forward, backward, leftward, and rightward directions. At this time, there is a problem that vibrations generated at the tip tool or others are transmitted to a housing, that is, a handle part held by an operator.

As measures against the vibrations, various techniques have been proposed. For example, a technique in which a cylindrical elastic member is disposed between a motor and a driving unit of a tip tool and a rotating shaft of the motor and a drive shaft are coupled with a universal joint inside the elastic member (see, for example, Patent Document 1) has been known.

### Patent Documents

Patent Document 1: Japanese Patent Application Laid-Open Publication No. S62-74564

### SUMMARY OF THE INVENTION

### Problems to be Solved by the Invention

Incidentally, in the technique disclosed in the Patent Document 1, a measure against vibrations is taken in the housing serving as a handle part. However, there has been a need for further measures from worksites in recent years. In particular, since vibrations generated in using this kind of power tools inevitably tend to result in reduced workability and larger operation errors, there has been a need for such further measures against vibrations from clients and other customers in order to satisfy more rigorous accuracy requirements.

The present invention has been made in consideration of such situations, and an object thereof is to provide techniques to solve the issues mentioned above.

### Means for Solving the Problems

A power tool according to the present invention includes: a housing having a driving source therein; a gear mechanism attached to an output shaft extending from the driving source; an inner cover covering a side of the housing from which the output shaft extends; a gear cover covering the gear mechanism; and an elastic member interposed between the housing and at least one the inner cover and the gear cover. The elastic member may be interposed between the housing and the inner cover. Also, the elastic member may be interposed between the gear cover and the housing. Also, a locking part is formed on one of a side of the housing and a side of the inner cover and the gear cover so as to protrude toward the other side, a recessed portion to be fitted with the locking part is formed on the other side, and the elastic member may be interposed between the locking part and the recessed portion. Also, the housing has a cylindrical shape, and the elastic member may be disposed throughout an entire periphery between the locking part and the recessed portion. Also, the housing is made up of a first housing and a second housing, and the elastic member may be sandwiched between the first housing and the second housing. Also, the housing has a cylindrical shape and has a locking part having a convex shape toward an inner side formed at a tip portion thereof, a fitting part having a recess shape is formed in a region for fixing the inner cover and the gear cover, the elastic member has a recess shape in a cross section and is formed in a ring shape and is disposed on the fitting part, and the locking part may be fitted with the elastic member having the recess shape in a cross section and disposed on the fitting part. Also, the output shaft of the driving source is supported by a bearing, and the bearing may be supported by the housing via a second elastic member.

### Effects of the Invention

According to the present invention, it is possible to achieve a power tool capable of reducing the transmission of vibrations to a housing held by a user.

### BRIEF DESCRIPTIONS OF THE DRAWINGS

FIG. 1 is a side view illustrating an overview of a grinder according to a first embodiment of the present invention;

FIG. 2 is a side view of the grinder illustrating a connecting part between a housing and a gear cover in an enlarged manner according to the first embodiment of the present invention;

FIG. 3 is a cross-sectional view taken along the line A-A of FIG. 2 according to the first embodiment of the present invention;

FIG. 4 is an enlarged view illustrating a region B shown in FIG. 2 according to the first embodiment of the present invention;

FIG. 5 is a side view of a grinder illustrating a connecting part between a housing and a gear cover in an enlarged manner according to a second embodiment of the present invention; and

FIG. 6 is a plan view of the grinder illustrating the connecting part between the housing and the gear cover in an enlarged manner according to the second embodiment of the present invention.

### DETAILED DESCRIPTION OF PREFERRED EMBODIMENTS

### First Embodiment

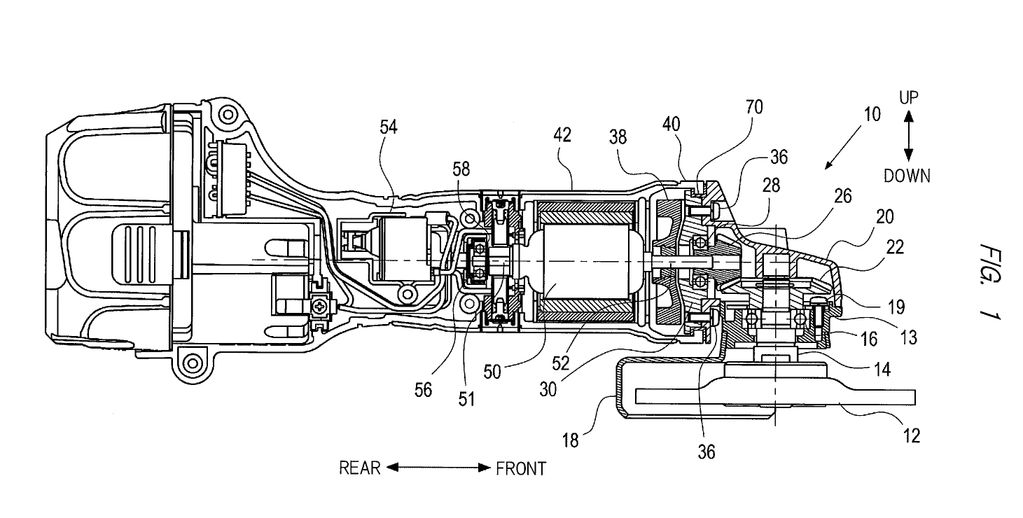

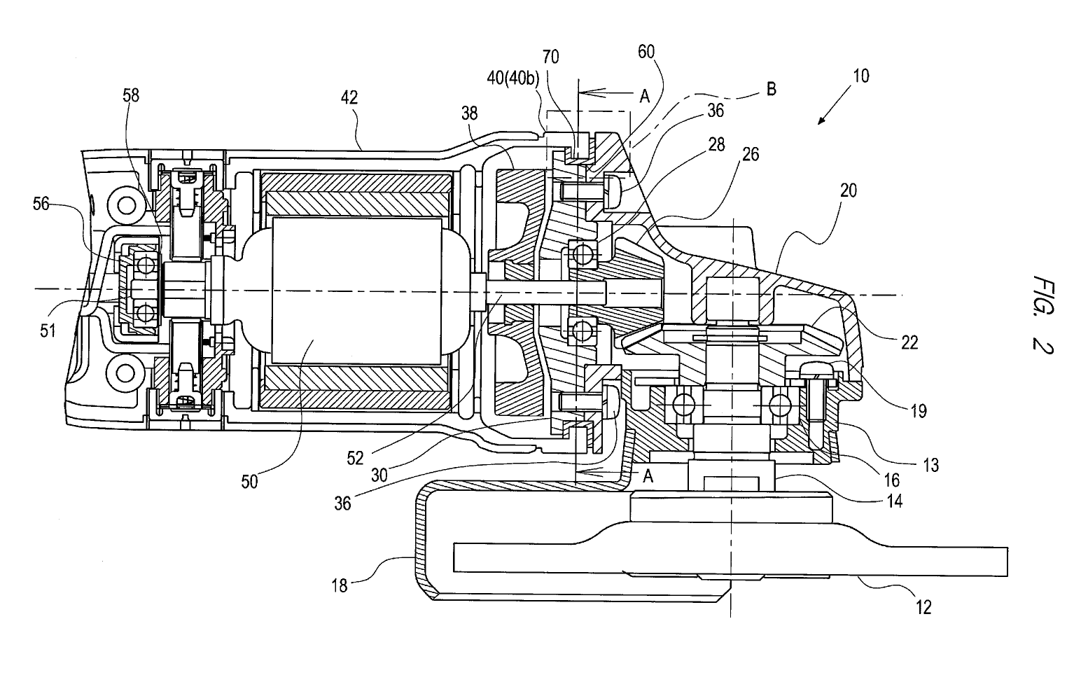

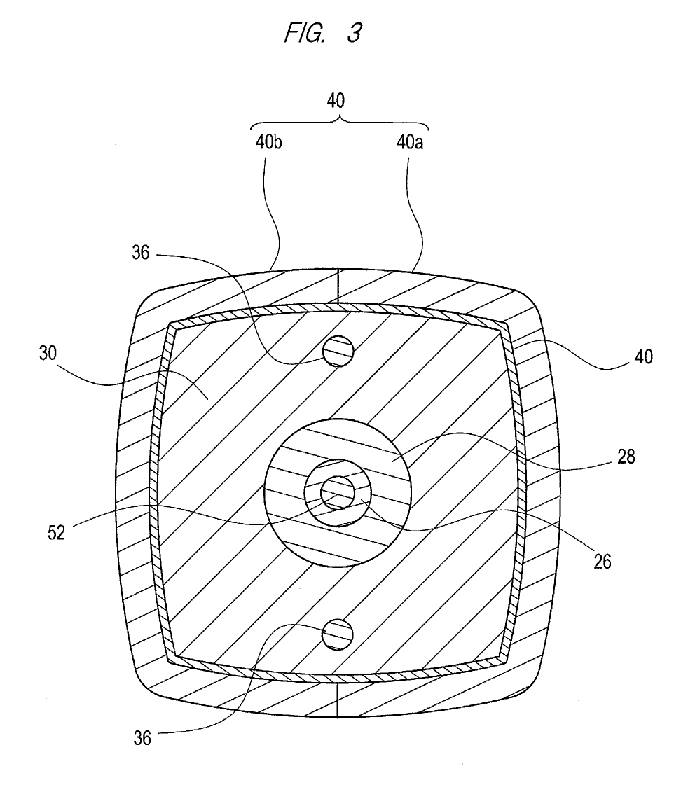

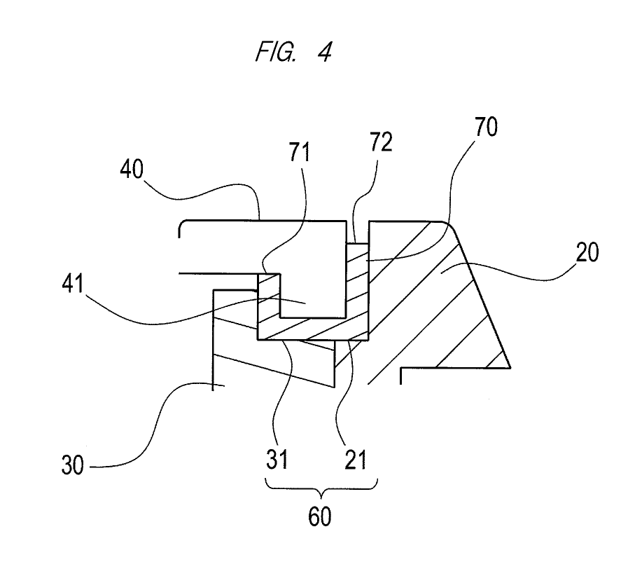

FIG. 1 is a side view illustrating an overview of a grinder 10 and partially includes a cross-sectional view. Also, FIG. 2 is a side view illustrating a connecting part between a housing 40 and a gear cover 20 shown in FIG. 1 in an enlarged manner. Furthermore, FIG. 3 is a cross-sectional view taken along the line A-A of FIG. 2. In the descriptions with reference to FIGS. 1 and 2, a right side is defined as a front of the grinder 10 and an upper side is defined as a top of the grinder 10. Furthermore, FIG. 4 is an enlarged view illustrating a region B shown in FIG. 2.

The grinder 10 includes a cylindrical housing 40 and a motor 50 serving as a driving source is stored in the housing 40. At a rear end portion of the housing 40, a battery is detachably mounted and the battery is connected to the motor 50 via a driving circuit having a switch 54. Note that an output shaft 51 on a rear side of the motor 50 is rotatably secured by an elastic member 56 and a bearing 58. This elastic member 56 may be omitted. Also, an elastomer 42 for slip resistance and others is attached at a predetermined position on a surface of the housing 40.

At a front end of the housing 40, an inner cover 30 for covering an opening at the front end of the housing 40 is attached and a gear cover 20 is attached with screws 36 on a front side of the inner cover 30. Furthermore, a packing gland 13 is attached on a lower side of the gear cover 20.

From this gear cover 20 (packing gland 13), a spindle 14 serving as an output shaft of the grinder 10 is protruded and a tip tool such as a disc-shaped grindstone 12 is attached at a tip of this spindle 14. Also, a dust collection cover 18 is disposed so as to cover a region behind the grindstone 12 in order to prevent fine particles such as grinding powder generated through grinding works from being scattered.

The spindle 14 is connected to the motor 50 serving as the driving source via a gear mechanism (bevel gear) constituted of a gear 22 and a pinion 26. Furthermore, the gear cover 20 covers and stores the gear 22 and the pinion 26.

Specifically, to an output shaft 52 extending forward from the motor 50 inside the housing 40, a fan 38 and a bevel gear shaped pinion 26 are attached in this order from the motor 50 side. The pinion 26 (output shaft 52 of the motor 50) is attached so that a bottom portion of the pinion 26 is supported by the inner cover 30 via a bearing 28. As a result, a gear portion of the pinion 26 is protruded forward from the inner cover 30 and is covered with the gear cover 20.

At a lower portion of the gear cover 20, the packing gland 13 is attached with a screw 19 and the gear 22 is rotatably supported and secured via a bearing 16. In other words, the gear cover 20 is provided with the packing gland 13 having a substantially cylindrical shape orthogonal to an axial direction of the housing 40 (extending direction of the output shaft 52 of the motor 50). The spindle 14 is disposed in the gear cover 20 so as to be rotatably supported by the packing gland 13 via the bearing 16, and a tip portion thereof is protruded outwardly (downward) from the packing gland 13. Inside the gear cover 20, a pair of bevel gears (gear mechanism constituted of the gear 22 and the pinion 26) is stored, and rotations of the motor 50 are transmitted to the spindle 14 through the bevel gears while changing a direction by 90 degrees.

Here, the housing 40, the inner cover 30, the gear cover 20 and a structure for fixing the elastic member 70 will be described in detail.

As shown in, for example, FIG. 3, the housing 40 is made up of two housings which can be bilaterally symmetrically separated (separable housings), that is, a first housing 40a and a second housing 40b. In the following descriptions, when the first housing 40a and the second housing 40b are not distinguished, the housings are simply referred to as the “housing 40”. Moreover, the housing 40 may be a cylindrical housing instead of separable housings.

At a tip portion of the housing 40, a convex locking part 41 protruding toward an inner side of the cylindrical shape is circumferentially provided. At a position where the locking part 41 is formed, the first housing 40a and the second housing 40b in an assembled state have a substantially rectangular cross-sectional shape, and each side of the cross section is slightly expanded outwardly.

Also, the elastic member 70 having a substantially U-shaped cross section is disposed so as to be fitted with the locking part 41 of the housing 40. More specifically, the elastic member 70 is sandwiched and fixed by the first housing 40a and the second housing 40b, and a rear end portion 71 of the substantially U-shaped elastic member 70 is in contact with an internal surface of the housing 40. Furthermore, a front end portion 72 is slightly recessed inwardly from an outer peripheral surface of the front end of the housing 40 and is in contact with an external surface of the housing 40. Namely, the rear end portion 71 and the front end portion 72 of the elastic member 70 are placed on an outer side relative to an internal end portion of the locking part 41, thereby preventing the elastic member 70 from coming off the housing 40.

On the other hand, in a region where the locking part 41 of the housing 40 (elastic member 70) is locked, the inner cover 30 has a substantially rectangular cross-sectional shape and each side of the cross section is slightly expanded outwardly so as to correspond to the shape of the locking part 41.

Furthermore, as a structure with which the locking part 41 is fitted, a front end portion of the inner cover 30 is formed into a stepped shape 31 which is lower by one step toward an inner side (output shaft 52 side). On the other hand, in the gear cover 20, a rear end shape to be fixed with the inner cover 30 is formed so that an outer peripheral surface of a rear end fits into the front end portion of the housing 40. However, the elastic member 70 is interposed between the outer peripheral surface of the rear end of the gear cover 20 and the front end portion of the housing 40.

Also, a stepped shape 21 which is lower by one step toward an inner side (output shaft 52 side) is formed at the rear end portion of the gear cover 20 as the shape for disposing the elastic member 70.

Furthermore, when the gear cover 20 is attached to the inner cover 30, a recess shape 60 is formed by the respective stepped shapes 21 and 31. In this portion of the recess shape 60, the elastic member 70 is disposed, and then the locking part 41 of the housing 40 is fitted so as to be locked to the elastic member 70. Since a fitting part is formed of the locking part 41 and the recess shape 60 and this configuration prevents the inner cover 30 and the gear cover 20 from coming off the housing 40, the housing 40 is fixed to the inner cover 30 and the gear cover 20 with only the locking part 41 described above, and no fixing member such as a screw is used. Note that the inner cover 30 and the gear cover 20 are fixed to the housing 40 by holding them between the first housing 40a and the second housing 40b. Note that, although the case where the convex locking part is disposed on a side of the housing 40 and the recess shape 60 is disposed on a side of the inner cover 30 and the gear cover 20 has been described, the recess shape may be disposed on a side of the housing 40 and the convex locking part may be disposed on a side of the inner cover 30 and the gear cover 20. Namely, any structure for preventing the inner cover 30 and the gear cover 20 from coming off the housing 40 can be adopted and the elastic member 70 is disposed in a connecting part thereof.

By adopting such a configuration, vibrations or the like of the grindstone 12 generated during the grinding works can be absorbed and blocked by the elastic member 70. In short, it is possible to prevent or significantly reduce vibrations of the gear cover 20 from being transmitted directly to the housing 40 or indirectly to the housing 40 via the inner cover 30. As a result, the transmission of vibrations to the housing 40 held by a user can be significantly reduced. Also, since the elastic member 70 has a recess shape, vibrations of the gear cover 20 in both of up-down and front-rear directions can be effectively absorbed. Furthermore, since the bearing 58 on the rear side of the motor 50 is supported via the elastic member 56, a rotator of the motor 50 is floated by the elastic member 56 and the elastic member 57 with respect to the housing 40, and thus the transmission of vibrations generated by rotations of the motor 50 to the housing 40 can also be suppressed. Furthermore, since the elastic member 70 is disposed throughout the entire periphery (frontward, rearward, leftward, rightward, upward, and downward) of the housing 40 (locking part 41), the transmission of vibrations to the housing 40 can be suppressed in all directions.

### Second Embodiment

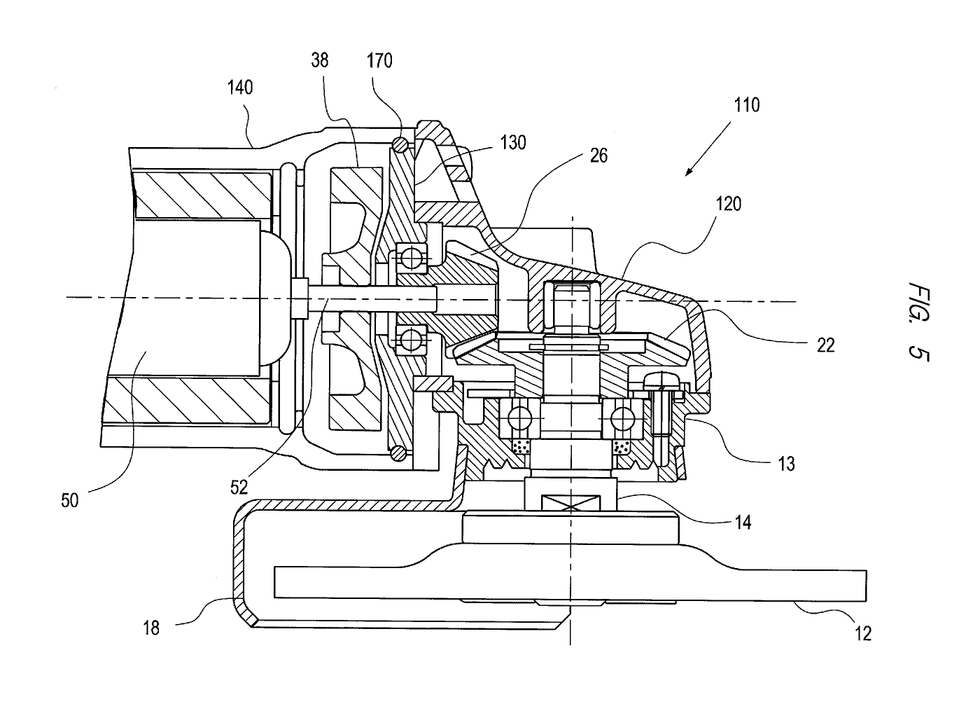

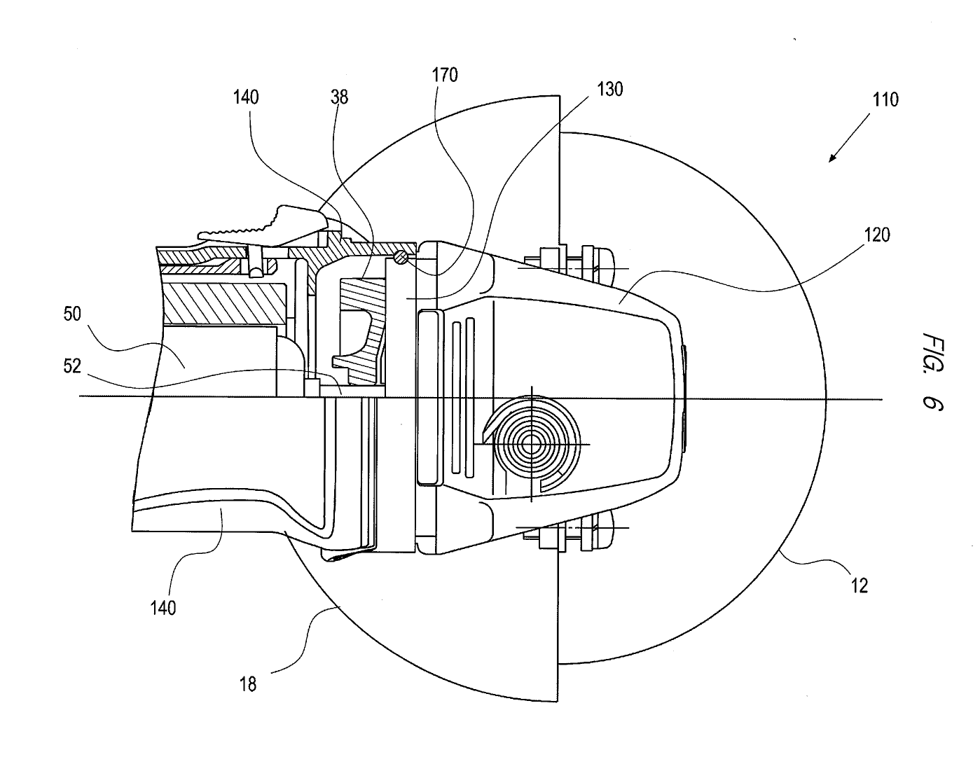

This embodiment is a modified example of the first embodiment, and differences will be mainly described by applying different reference characters. FIG. 5 is a side view illustrating a connecting part between a housing 140 and a gear cover 120 of a grinder 110 according to this embodiment in an enlarged manner. Also, FIG. 6 is a plan view illustrating a region of a tip portion of the grinder 110 shown in FIG. 5, and a half of it is a cross-sectional view illustrating the state where the housing 140 has been removed.

The different from the first embodiment is the form of an elastic member 170. Specifically, the elastic member 170 has a circular cross-sectional shape, and is interposed only between the housing 140 and an inner cover 130. On the other hand, no elastic member 170 is interposed between the gear cover 120 and the housing 140, and the gear cover 120 and the housing 140 are slightly separated.

By adopting such a configuration, like the first embodiment, the transmission of vibrations from the gear cover 120 to the housing 140 via the inner cover 130 can be reduced.

In the foregoing, the present invention has been described based on the embodiments. Those skilled in the art can understand that these embodiments are provided by way of examples, various modified examples may be available including combination of the components, and such various modified examples are included in a range of the present invention. For example, although a grinder is illustrated as a power tool in the embodiments described above, the embodiments can be applied also to a polisher other than the grinder.

### DESCRIPTION OF REFERENCE CHARACTERS

10, 110 grinder

13 packing gland

20, 120 gear cover

21, 31 stepped shape

22 gear

26 pinion

30, 130 inner cover

40, 140 housing

40a first housing

40b second housing

41 locking part

50 motor

52 output shaft

56, 57, 70, 170 elastic member

60 recess shape

1. A power tool comprising:
a housing having a driving source therein;
a gear mechanism attached to an output shaft extending from the driving source;
an inner cover covering a side of the housing from which the output shaft extends;
a gear cover covering the gear mechanism; and
an elastic member interposed between the housing and at least one the inner cover and the gear cover.

2. The power tool according to claim 1,
wherein the elastic member is interposed between the housing and the inner cover.

3. The power tool according to claim 1,
wherein the elastic member is interposed between the gear cover and the housing.

4. The power tool according to claim 1,
wherein a locking part is formed on one of a side of the housing and a side of the inner cover and/or the gear cover so as to protrude toward the other side,
a recessed portion to be fitted with the locking part is formed on the other side, and
the elastic member is interposed between the locking part and the recessed portion.

5. The power tool according to claim 4,
wherein the housing has a cylindrical shape, and the elastic member is disposed throughout an entire periphery between the locking part and the recessed portion.

6. The power tool according to claim 5,
wherein the housing is made up of a first housing and a second housing, and the elastic member is sandwiched between the first housing and the second housing.

7. The power tool according to claim 1,
wherein the housing has a cylindrical shape and has a locking part having a convex shape toward an inner side formed at a tip portion thereof,
a fitting part having a recess shape is formed in a region for fixing the inner cover and/or the gear cover,
the elastic member has a recess shape in a cross section and is formed in a ring shape and is disposed on the fitting part, and
the locking part is fitted with the elastic member having the recess shape in a cross section and disposed on the fitting part.

8. The power tool according to claim 1,
wherein the output shaft of the driving source is supported by a bearing, and the bearing is supported by the housing via a second elastic member.
